(19) United States
(12) Patent Application Publication
(10) Pub. No.: US 2023/0111978 A1
(43) Pub. Date: Apr. 13, 2023

(54) CROSS-EXAMPLE SOFTMAX AND/OR CROSS-EXAMPLE NEGATIVE MINING

(71) Applicant: GOOGLE LLC, Mountain View, CA (US)

(72) Inventors: Andreas Veit, New York, NY (US); Kimberly Wilber, New York, NY (US)

(21) Appl. No.: 17/910,756

(22) PCT Filed: Mar. 18, 2020
(86) PCT No.: PCT/US2020/023320

§ 371 Date: Sep. 9, 2022

Related U.S. Application Data
(60) Provisional application No. 62/988,270, filed on Mar. 11, 2020.

(51) Int. Cl. G06N 3/08; G06F 16/903

(52) U.S. Cl. CPC G06N 3/08; G06F 16/90335

(57) ABSTRACT

Techniques are disclosed that enable learning an embedding space using cross-examples, where a distance between a query and an electronic resource in the embedding space provides an indication of the relevance of the electronic resource to the query. Various implementations include learning the embedding space using cross-example Softmax techniques. Various implementations include leaning the embedding space using cross-example negative mining. Additional or alternative techniques are disclosed that enable determining an electronic resource for a query based on comparing a query vector (e.g., a embedding space representation of the query) with a set of pre-stored candidate electronic resource vectors (e.g., an embedding space representation of a set of candidate electronic resources).

### BACKGROUND

Information retrieval systems can rely on neural network models to learn embedding spaces in which distance can encode the relevance between a given query and a candidate response to the given query. These embedding spaces can be trained using conventional methods (e.g., sampled Softmax, stochastic negative mining, etc.) by optimizing the relevance between the relative ordering of candidate responses given a query.

### SUMMARY

Implementations described herein are directed towards learning an embedding space using cross-examples, such that distances in the learned embedding space are globally calibrated across queries. Distances generated using conventional techniques may not be comparable across queries, which may lead to difficulties in determining, for example, how relevant a document is to a query based on the distance. For example, in a conventionally learned embedding space (e.g., an embedding space learned using sampled Softmax methods, stochastic negative mining methods, etc.), a first distance between a first query and a document related to the first query may be greater than the distance between a second query and a document not related to the second query. In other words, using conventional techniques, the distance between the first query and a corresponding related document cannot be compared with the distance between the second query and corresponding related and/or unrelated document(s). Moreover, using conventional techniques, it may be ascertainable that a given document is closest distance-wise to a query, but it may not be ascertainable how relevant that given document truly is to the query (e.g., is it a really close match, or just a decent match).

In contrast, implementations described herein are directed towards learning embedding space(s) using cross-examples, such that distances in the learned embedding space are globally calibrated. For example, the distance between the first query and the first corresponding document should not be greater than the distance between the second query and document(s) unrelated to the second query. In other words, distances between the first query and one or more candidate documents can be compared with distances between the second query and one or more candidate documents. Moreover, the distances between a given query and candidate documents are meaningful and reflect the true relevance of those candidate documents to the given query.

In some implementations, one or more neural network models can be trained using cross-examples to learn an embedding space. For example, an input model can be trained to generate a query vector by processing a query, where the query vector is an embedding space representation of the query. Additionally or alternatively, a resource model can be trained to generate an electronic resource vector by processing an electronic resource (e.g., an image, a document, a webpage, a bounding box, and/or additional resource(s)), where the electronic resource vector is the embedding space representation of the electronic resource.

In some implementations, a batch of training data can include ground truth query/electronic resource pairs, where each query in the batch of training data has a single corresponding electronic resource, and where each electronic resource only has a corresponding single query. In some implementations, each query can be processed using the input model to generate a corresponding query vector. Similarly, in some implementations, each electronic resource can be processed using the resource model to generate a corresponding electronic resource vector. A relevance score (e.g., a distance in the embedding space) can be generated for each query/electronic resource ground truth pair based on the corresponding query vector and corresponding electronic resource vector for the query/electronic resource ground truth pair. For example, the relevance score can be generated by determining a dot product between the corresponding query vector and corresponding electronic resource vector. Additionally or alternative, a negative relevance score (e.g., a distance in the embedding space) can be determined for each given query and each electronic resource that is not a ground truth pairing with the given query, based on the corresponding query vector and corresponding electronic resource vector. For example, the negative relevance score can be generated by determining a dot product between the corresponding query vector and the corresponding electronic resource vector that is not a ground truth pairing with the given query. In some implementations, a pairwise similarity matrix can be generated based on the queries in the batch of training data and the electronic resources in the batch of training data.

In some implementations, a query loss can be determined for each query in the batch of training data. For example, each query loss can be based on the relevance score for the corresponding query, and one or more of the negative relevance scores for at least one additional query in the batch of training data. In other words, each query loss can be based on the relevance score for the query and at least one negative relevance score for one or more cross-examples (i.e., the one or more additional queries). In some implementations, a training batch loss can be determined based on the query losses for each query in the batch. The training batch loss can then be used to update (e.g., backpropagation) one or more portions of the input model, one or more portions of the resource model, and/or one or more portions of additional model(s).

In some implementations, each query loss can be generated using a cross-example Softmax method, where each query loss is based on the relevance score corresponding to the query, and each of the generated negative query losses. In other words, the query loss is based on the relevance score for the corresponding query, each of the negative relevance scores generated for the corresponding query, and each of the negative relevance scores generated for each additional query in the batch. In contrast, a query loss can be determined using conventional Softmax methods (e.g., conventional sampled Softmax) based on the relevance score generated for the corresponding query and the negative relevance scores generated for the corresponding query, without being based on negative relevance scores generated for additional queries in the batch of training data.

Additionally or alternatively, each query loss can be generated using a cross-example negative mining method, where each query loss is based on the relevance score generated for the corresponding query and a subset of the negative relevance scores generated for the batch of training data (e.g., a subset of the negative relevance scores generated for the query and/or the additional queries). In some implementations, the subset of negative relevance scores can be selected based on whether a negative relevance score satisfies one or more conditions. For example, the subset of negative relevance scores can be selected to include the negative scores with the highest values (e.g., the top k negative relevance scores with the k highest values). In contrast, a query loss generated using a stochastic negative mining method is based on the relevance score generated for the corresponding query and a subset of the negative relevance scores generated for the corresponding query, excluding negative relevance scores generated for additional queries.

In some implementations, a trained input model can be used to determine a corresponding electronic resource. For example, a query vector can be generated by processing the query using the trained input model. In some implementations, the query vector can be compared with pre-stored candidate electronic resource vectors, where each candidate electronic resource vector is previously generated by processing the candidate electronic resource using a resource model. In some implementations, the input model and the resource model can be trained using the same batch loss(es). A candidate electronic resource vector can be selected based on the comparing. For example, the candidate electronic resource vector can be selected based on the smallest distance between the candidate electronic resource vector and the query vector. Additionally or alternatively, the electronic resource corresponding with the query can be determined based on the selected candidate electronic resource vector. In some implementations, a computing system can perform action(s) based on the determined electronic resource.

For example, a computing system can be used to determine an image (i.e., the electronic resource) responsive to a natural language query (i.e., the query). The input model can process the natural language query to generate the query vector. Pre-stored candidate image vectors can be generated by processing candidate images using the resource model. In the illustrated example, the input model used to process natural language queries can be a different model type and/or have a different model structure than the resource model used to process candidate images. In some implementations, the input model and the resource model can be trained using the same generated training loss(es). In some of those implementations, the input model can be simultaneously trained with the resource model. A candidate image vector can be selected based on a distance between the selected candidate image vector and the query vector. In some implementations, the image corresponding to the natural language query can be determined based on the selected pre-stored candidate image vector. In some implementations, the computing system can perform action(s) based on the determined image, such as displaying the image on a screen of the computing system.

As an additional example, a computing system can be used to determine a bounding box (i.e., the electronic resource) for an object captured in an image (i.e., the query). The image can be processed using the input model to generate an image vector. Pre-stored candidate bounding box vectors can be generated by processing candidate bounding boxes using a response model. The image vector can be compared with each of the pre-stored candidate bounding box vectors, and a candidate bounding box vector can be selected based on the comparing. For instance, the candidate bounding box vector with the shortest distance to the image vector can be selected. The bounding box can be determined based on the candidate bounding box vector. In some implementations, the computing system can perform action(s) based on the determined bounding box, such as displaying the bounding box around the object in the image, identifying the object captured in the bounding box, etc.

Accordingly, various implementations set forth techniques for learning embedding spaces using cross-examples (e.g., using negative relevance score(s) generated for additional queries in a batch of training data). In contrast, conventional techniques can learn embedding spaces based on negative relevance score(s) generated for a given query, excluding additional negative relevance score(s) generated for additional queries. In some cases, the electronic resource most closely corresponding to a query (e.g., the electronic closest to the query in the embedding space learned using conventional techniques) is not particularly relevant to the query. Computing resources (e.g., processor cycles, memory, battery power, etc.) can be conserved by providing a user with only electronic resources which are known to be responsive to a query based on a distance, in an embedding space learned using cross-examples, between the query and the electronic resource.

The above description is provided only as an overview of some implementations disclosed herein. These and other implementations of the technology are disclosed in additional detail below.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 illustrates an example environment in which various implementations disclosed herein may be implemented.

FIG. 2A illustrates an example of generating relevance scores in accordance with various implementations disclosed herein.

FIG. 2B illustrates an example of generating negative relevance scores in accordance with various implementations disclosed herein.

FIG. 2C illustrates an example of generating a batch loss based on relevance score(s) and negative relevance score(s) in accordance with various implementations disclosed herein.

FIGS. 3A and 3B illustrate an example embedding space generated using conventional methods.

FIGS. 3C and 3D illustrate an example embedding space generated in accordance with implementations disclosed herein.

FIG. 4A illustrates an example pairwise similarity matrix generated based on a batch of training data.

FIG. 4B illustrates an example of ground truth pairings for the batch of training data.

FIG. 4C illustrates an example of generating a query loss using a conventional Softmax method.

FIG. 4D illustrates an example of generating a query loss using a conventional stochastic negative mining method.

FIG. 4E illustrates an example of generating a query loss using a cross-example Softmax method in accordance with various implementations disclosed herein.

FIG. 4F illustrates an example of generating a query loss using a cross-example negative mining method in accordance with various implementations disclosed herein.

FIG. 5 is a flowchart illustrating an example process of training an input model and/or a response model in accordance with various implementations disclosed herein.

FIG. 6 is a flowchart illustrating an example process of generating a query loss using a cross-example Softmax method in accordance with various implementations disclosed herein.

FIG. 7 is a flowchart illustrating an example process of generating a query loss using a cross-example negative mining method in accordance with various implementations disclosed herein.

FIG. 8 is a flowchart illustrating an example process of determining an electronic resource for a query in accordance with various implementations disclosed herein.

FIG. 9 illustrates an example architecture of a computing device.

### DETAILED DESCRIPTION

Modern image retrieval systems increasingly may rely on deep neural networks to learn embedding spaces in which distance encodes the relevance between a given query and an image. These embedding spaces conventionally can be trained by optimizing the relative ordering of documents given a query. However, this can pose a challenge as the resulting absolute distances may not be comparable across queries, leading to difficulties in determining if a document is relevant to a query solely based on their distance. Techniques disclosed herein are directed towards cross-example Softmax methods to address the above challenge. In some implementations, in each iteration, the proposed cross-example Softmax loss encourages that all queries are closer to their matching images than all queries are to all irrelevant images. This can lead to a globally more calibrated similarity metric, and can make distance more interpretable as a measure of relevance. Additional or alternative techniques are directed towards cross-example negative mining methods, in which each query document pair can be compared to the “hardest” negative comparisons across the entire batch. In some implementations, it can be shown that the proposed methods can effectively improve global calibration and/or can increase retrieval performance.

The goal of large-scale information retrieval can be to efficiently find relevant documents for a given query among potentially billions of candidates. A canonical example is an image search: finding relevant images given a text query. One conventional implementation can be to learn a real-valued scoring function to rank the set of candidate images each query might be related to. Since using large neural networks to compute the relevance of each query-image pair can be prohibitively expensive, recent deep learning systems can solve this task by co-embedding queries and images into shared vector spaces. By encoding semantic relevance as distance in the vector space, these systems can model complex semantic relationships while still allowing for efficient retrieval using approximate nearest neighbor search through a large database of images.

Conventional deep metric learning approaches can rely on pair-wise or triplet comparisons to place a query close to relevant images and far away from irrelevant images in the vector space. However, inspired by the success of large-scale classification problems like ImageNet, many deep metric learning models now can use Softmax with cross entropy. Note that akin to information retrieval systems, models like ResNet or VGG can maximize the dot product between an image query representation and one relevant label from a fixed set of 1,000 labels. Labels can be encoded in the last layer's weight matrix. In contrast to ImageNet training, it can be mostly infeasible for information retrieval systems to compute the Softmax likelihood for all documents which could be in the billions, the Softmax can instead be computed over a small random subset of documents. This is commonly referred to as conventional Sampled Softmax. In practice, this can be achieved by embedding a random batch of pairs of queries/documents that are known to be relevant to one another into their vector representations. For a given query, the other documents in the batch can be efficiently re-used as negatives. Since most of these random documents are unlikely to be informative to each query, stochastic negative mining can be used such that the most informative negative documents can be used, e.g. those with the highest similarity score.

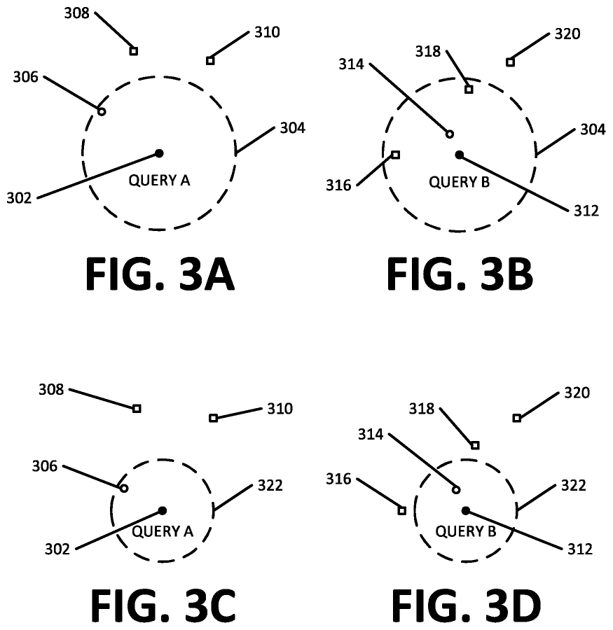

While Sampled Softmax and triplet-based methods have been shown to be very effective in learning representations that capture relative semantic similarity, a key challenge remains. Specifically, these methods are invariant to absolute distance in the vector space, since they only optimize the relative distance between a query and its matching document compared to non-relevant documents. As a consequence, distances are not comparable across queries and cannot be interpreted as an absolute measure of relevance. As illustrated in FIGS. 3A and 3B, the relevant image 306 for query A 302 is further away from its query than irrelevant images 316 and 318 are to query B 312. This lack of calibration can become a problem for retrieval systems that commonly employ global confidence thresholds to determine which distance results are considered relevant.

In some implementations, cross-example Softmax methods can address this challenge by directly optimizing for retrieval as well as similarity score calibration so that query/document similarity scores are comparable across multiple queries. In some implementations, the cross-example Softmax method extends Softmax by introducing cross-example comparisons. In some implementations, instead of maximizing the ratio between the distance of a query to its matching document compared to its distances to all other documents, cross-example Softmax can maximizes the ratio between the distance of a query to its matching document and the distances of all query/document pairs that are not relevant to one another. This can encourage any matching pair to be closer in the vector space than any non-matching pair. FIGS. 3C and 3D illustrates the effect of cross-example Softmax and how it leads to calibrated distance scores.

In some implementations, the proposed method further can allow an extension of the concept of stochastic negative mining to cross-example negative mining. Instead of mining the most informative negative documents only for the given query, non-matching pairs can be selected with the highest similarity score, even if they are for a different query.

Metric learning using deep models has been applied to many applications, especially where the output space is very large. Early approaches are based upon Siamese networks with contrastive loss on pairwise data or relative triplet similarity comparisons. Inspired by the success of large-scale classification tasks on ImageNet, more recent models can be trained using sampled Softmax loss with cross entropy. Recently, several works have proposed modifications to the sampled Softmax loss, by normalization, adding margins, and tuning the scaling temperature. These approaches focus on optimizing the relative ordering of labels given an anchor query. In contrast, cross-example Softmax methods disclosed herein can optimize for each input query, the score of the correct label against the entire distribution of all possible negative query/label pairs in the entire batch, even across queries.

In the setting of large output spaces, for any given query, most documents may not be relevant and thus including them in the loss function may not be informative for the optimization. To address this challenge, several works have proposed to mine for the hardest and most informative negative labels. However, as an approximation of per-query Softmax, these methods can perform negative mining only with respect to one single query at a time. Cross-example negative mining methods disclosed herein can use negative example mining across examples, wherein a system can mine for the globally hardest negative query/document comparison in the batch.

There has been a sustained interest in score calibration to ensure scores are consistently normalized or interpretable. One common approach is to interpret the output of the Softmax function applied to model logits as probabilities. While the output of a Softmax is technically a probability distribution in the sense that it is normalized, computing the probability for any label also requires the comparison to all other labels. In the setting of large output spaces, this is generally not possible, because the probability space is too large to calculate. To address this challenge, techniques disclosed herein are directed towards a new loss function that explicitly encourages the underlying logits to be calibrated. This can be done during training, not as a post-recognition calibration step. This can allow the comparison of label scores across queries without needing to compute scores for all other labels.

Consider the multiclass classification setting with a sample of instances x E X and their associated labels γ ∈ Y with |Y|=K. In some implementations, the goal can be to learn a scoring function ƒ: X→ [symbol] ^{K} that is able to sort the labels for each instance according to their relevance. The information retrieval setting at hand can be defined analogous with a set of queries X and associated relevant documents Y. In some implementations, the goal can be to learn a scoring function which can sort all documents according to their relevance for a given query.

In a text-to-image retrieval application example, xᵢ is a text query and γᵢ is its corresponding relevant image. In some implementations, to score the relevance between a query and an image, a text encoder ƒₜₑₓₜ: (xᵢ)→xᵢ ∈ [symbol] ^{d} and an image encoder ƒ_{image}: (γᵢ)→γᵢ ∈ [symbol] ^{d} f can be learned that project the text and image into a shared d-dimensional embedding space. In some implementations, the relevance score between a query xᵢ and an image γᵢ can be the dot product between their vector representations s_{i,j}= [symbol] xᵢ·γⱼ [symbol] .

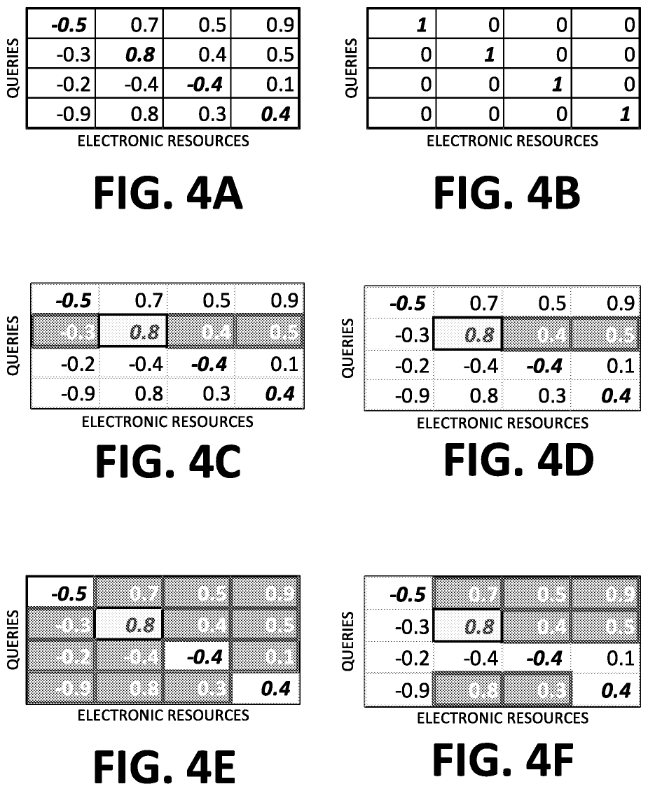

In the standard multiclass classification setting, a Softmax Cross-Entropy loss over the whole label space can be used to optimize the model, i.e., the score of the correct label can be compared to the score of all other labels. Ideally, in the retrieval setting a system could also compare the score of a matching document to all other documents in the database. However, since the number of documents may be in the billions, this can become prohibitive. To address this challenge, the Softmax Cross-Entropy loss is commonly only computed over a random subset of labels, which is generally referred to as Sampled Softmax. Specifically, consider a mini-batch comprising N corresponding query/document pairs Bₜ={(x₁, γ₁), . . . , (x_{N}, γ_{N})}, uniformly sampled from an epoch of batches B. Given the vector representations of all text queries and images from the mini-batch, a system can compute the pairwise similarity matrix between all possible pairs S ∈ [symbol] ^{NxN}=s_{i,j}, ∀i,j ∈ [1, . . . , N] An example of such a pairwise similarity matrix for a mini-batch of size N=4 is illustrated in FIG. 4A.

With the number of overall documents being very large and the random subset of documents within each mini-batch being relatively small, it can be commonly assumed that for a given query xᵢ, within the batch only its corresponding document γᵢ is relevant. In some implementations, all other documents γⱼ, j≠i sampled within the same batch can be assumed to be irrelevant to that query. The matching relationship between queries and documents within a batch is illustrated in FIG. 4B with 1 indicating a matching relationship (e.g., a ground truth relationship) and 0 indicating a non-match. Formally, N_{i,B}_{ₜ} can be the set of similarity scores between query xᵢ and all non-matching documents in the batch, i.e., except for the query's corresponding document γᵢ. In FIGS. 4A-4F this would be all scores in row i of S except the relevant document.

N_{i,B}_{ₜ}={S_{i,j}:j≠i} (1)

In some implementations, Sampled Softmax Cross-Entropy can be defined as a relative ranking loss between the relevance score of a query and its matching document and its relevance scores to all non-matching documents s ∈ N_{i,B}_{ₜ}. Formally,

$${ℒ}_{{B}_{t}} = - \frac{1}{N} {\sum }_{i = 1}^{N} log ( \frac{{e}^{{s}_{i , i}}}{{e}^{{s}_{i , i}} + {\sum }_{s ∈ {N}_{i , {B}_{t}}} {e}^{s}} ) \qquad ( 2 )$$

FIG. 4C illustrates the per-example loss for the second query. The score of the matching pair s_{2,2} is emphasized in light grey and N_{2,B}_{ₜ} is emphasized in dark grey. The figure highlights that the loss only considers pairs from the same query.

In the Sampled Softmax approach, a relevant document is only compared to a small subset of random documents. As a consequence, most of these documents will be irrelevant to the query and thus uninformative to guide the optimization. As a means to overcome this, Stochastic Negative Mining only selects the most difficult negative documents for each query within the randomly drawn subset of documents of the batch. Formally, let topk(N_{i,B}_{ₜ}) be the set of the top k largest scores within the set of negative scores for query xᵢ.

With this, the modified loss can be defined only over the most difficult documents for each query as

$${ℒ}_{{B}_{t}} = - \frac{1}{N} {\sum }_{i = 1}^{N} log ( \frac{{e}^{{s}_{i , i}}}{{e}^{{s}_{i , i}} + {\sum }_{s ∈ top k ( {N}_{i , {B}_{t}} )} {e}^{s}} ) \qquad ( 3 )$$

FIG. 4D shows this scenario. The set of negatives now only comprise the hardest comparisons for the given query. In the diagram, the dark grey negative scores are the topk(N_{i,B}_{ₜ}).

From equations (2) and (3) as well as the illustrations in FIGS. 4C and 4D, it becomes clear that Sampled Softmax captures the distance of documents only relative with respect to a single given query. Since the loss term is invariant to absolute distance and does not compare distances across queries, distances in the learned vector space are not comparable across queries.

To encourage global calibration such that distance can be used as an absolute measure of relevance, techniques disclosed herein are directed towards Cross-Example Softmax which extends Softmax by introducing cross-example negatives. The proposed loss can encourage that all queries are closer to their matching documents than all queries are to all irrelevant documents.

In some implementations, N_{B}_{ₜ} can be the pairwise comparisons between all queries in batch Bₜ and the documents of the same batch which they are not related to. In some implementations, queries can be assumed to be only related to their respective document, this can correspond to all off-diagonal entries in S. In some implementations,

N_{B}_{ₜ}=U_{i∈[1, . . . ,N]}N_{i,B}_{ₜ} (4)

In some implementations, using equation (4), Cross-Example Softmax Cross-Entropy can be defined as

$${ℒ}_{{B}_{t}} = - \frac{1}{N} {\sum }_{i = 1}^{N} log ( \frac{{e}^{{s}_{i , i}}}{{e}^{{s}_{i , i}} + {\sum }_{s ∈ {N}_{{B}_{t}}} {e}^{s}} ) \qquad ( 5 )$$

FIG. 4E illustrates that for Cross-Example Softmax the loss for a single query can include all negative scores from N_{B}_{ₜ}, even query/document pairs from different queries.

In some implementations, Stochastic Negative Mining can be extended using cross-example negatives to mine for the hardest negative comparisons across the entire batch. Akin to the formulation above, let topk(N_{i,B}_{ₜ}) be the set of the top k largest scores within the set of negative scores of the entire batch. In some implementations, the Cross-Example Negative Mining loss can be defined as:

$${ℒ}_{{B}_{t}} = - \frac{1}{N} {\sum }_{i = 1}^{N} log ( \frac{{e}^{{s}_{i , i}}}{{e}^{{s}_{i , i}} + {\sum }_{s ∈ top k ( {N}_{{B}_{t}} )} {e}^{s}} ) \qquad ( 6 )$$

This cross-example negative mining loss is illustrated in FIG. 4F. In the example illustrated in FIG. 4F, negative scores for each query are mined from the entire batch. This means that the set of mined scores could contain all negative scores from some queries, like row 1 in the figure, and no negative scores from others, like row 3 in the figure.

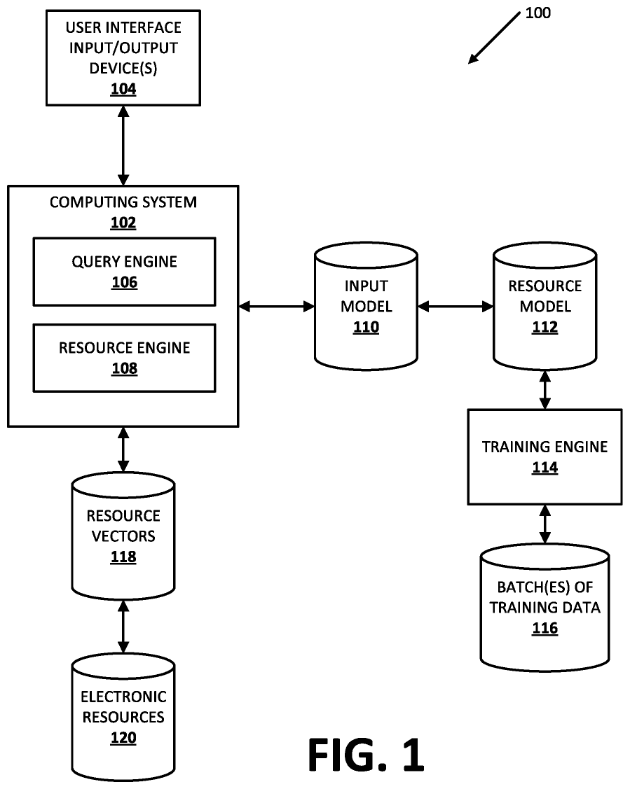

Turning now to the figures, FIG. 1 illustrates a block diagram of an example environment 100 in which implementations disclosed herein may be implemented. The example environment 100 includes a computing system 102 which can include query engine 106, resource engine 108, and/or additional engine(s) (not depicted). Additionally or alternatively, computing system 102 may be associated with one or more user interface input/output devices 104. Furthermore, computing system 102 may be associated with input model 110, resource model 112, training engine 114, one or more batches of training data 116, resource vectors 118, electronic resources 120, and/or one or more additional components (not depicted).

In some implementations, computing system 102 may include may include user interface input/output devices 104, which may include, for example, a physical keyboard, a touch screen (e.g., implementing a virtual keyboard or other textual input mechanisms), a microphone, a camera, a display screen, and/or speaker(s). The user interface input/output devices may be incorporated with one or more computing system 102 of a user. For example, a mobile phone of the user may include the user interface input output devices; a standalone digital assistant hardware device may include the user interface input/output device; a first computing device may include the user interface input device(s) and a separate computing device may include the user interface output device(s); etc. In some implementations, all or aspects of computing system 102 may be implemented on a computing system that also contains the user interface input/output devices. In some implementations computing system 202 may include an automated assistant (not depicted), and all or aspects of the automated assistant may be implemented on computing device(s) that are separate and remote from the client device that contains the user interface input/output devices (e.g., all or aspects may be implemented “in the cloud”). In some of those implementations, those aspects of the automated assistant may communicate with the computing device via one or more networks such as a local area network (LAN) and/or a wide area network (WAN) (e.g., the Internet).

Some non-limiting examples of computing system 102 include one or more of: a desktop computing device, a laptop computing device, a standalone hardware device at least in part dedicated to an automated assistant, a tablet computing device, a mobile phone computing device, a computing device of a vehicle (e.g., an in-vehicle communications system, and in-vehicle entertainment system, an in-vehicle navigation system, an in-vehicle navigation system), or a wearable apparatus of the user that includes a computing device (e.g., a watch of the user having a computing device, glasses of the user having a computing device, a virtual or augmented reality computing device). Additional and/or alternative computing systems may be provided. Computing system 102 may include one or more memories for storage of data and software applications, one or more processors for accessing data and executing applications, and other components that facilitate communication over a network. The operations performed by computing system 102 may be distributed across multiple computing devices. For example, computing programs running on one or more computers in one or more locations can be coupled to each other through a network.

As illustrated in FIG. 1, training engine 114 can be used to train input model 110 and/or resource model 112. In some implementations, training engine 114 can process one or more batches of training data 116 to generate a batch loss, where the batch loss can be used to update one or more portions (e.g., through backpropagation) of input model 110 and/or resource model 112. For example, a batch of training data 116 can include a set of queries, a set of electronic resources, and ground truth pairings between the queries and the electronic resources. In some implementations, each of the ground truth pairings is of a corresponding one of the electronic resources to a corresponding one of the queries. In some of those implementations, each electronic resource only has a corresponding single one of the ground truth pairings.

In some implementations, training engine 114 can generate a set of query vectors by processing each query, in the set of queries of a batch of training data 116, using input model 110. Each query vector can be an embedding space representation of the corresponding query. Additionally or alternatively, training engine 114 can generate a set of electronic resource vectors by processing each electronic resource, in the set of electronic resources of a batch of training data 116, using resource model 112. Each electronic resource vector can be an embedding space representation of the corresponding electronic resource. In some implementations, the embedding space of the query vectors is a shared embedding space with the electronic resource vectors. Additionally or alternatively, training engine 114 can determine the relevance between each query vector and each electronic resource vector corresponding to the batch of training data 116. In some implementations, a relevance score can be determined for each ground truth query/electronic resource pairing. For example, training engine 114 can determine the relevance score (e.g., a distance in embedding space) between the corresponding query vector and the corresponding electronic resource vector of the ground truth pairing by determining a dot product between the corresponding query vector and the corresponding electronic resource vector. Additionally or alternatively, training engine 114 can determine a negative relevance score for each query vector and for each electronic resource vector that is in addition to the corresponding electronic resource vector with the ground truth relationship to the query. In other word, a negative relevance score can be generated for each query and electronic resource pair in addition to the ground truth pairings. In some implementations, training engine 114 can determine each negative relevance score (e.g., a distance in embedding space) between a query vector and a corresponding electronic resource vector, in addition to the ground truth electronic resource pairing for the query, by determining a dot product between the corresponding query vector and the corresponding electronic resource vector.

Training engine 114 can determine a query loss corresponding to a query in the set of queries of the batch of training data 116. In some implementations, a query loss can be based on the relevance score generated for the corresponding query, and at least one negative relevance score generated for at least one additional query in the batch of training data 116. In other words, the query loss can be generated using a cross-example (e.g., the at least one negative relevance score generated for at least one additional query in the batch of training data 116). In some implementations, training engine 114 can generate a query loss using a cross-example Softmax method, where the query loss is generated based on (1) the relevance score for the corresponding query, (2) each of the negative relevance scores generated for the corresponding query, and (3) each of the negative relevance scores generated for each additional query in the batch of training data.

Additionally or alternatively, training engine 114 can generate a query loss using a cross-example negative mining method. In some implementations, training engine 114 can select a subset of the negative relevance scores for use in generating the query loss using a cross-example negative mining method, where training engine 114 can select one or more negative relevance scores that satisfy one or more conditions. For example, training engine 114 can select each negative relevance score corresponding to a batch of training data 116 that is higher than a threshold value. Additionally or alternatively, training engine 114 can select the top k negative relevance scores corresponding to a batch of training data 116 (e.g., training engine 114 can select the top 10 negative relevance score values, the top 100 negative relevance score values, etc.). In some implementations, training engine 114 can generate a negative relevance score for a query based on the relevance score for the query and the selected subset of the negative relevance scores. In some of those implementations, the selected subset of the negative relevance scores includes one or more negative relevance scores generated for an additional query.

Training engine 114 can generate a batch loss for the batch of training data 116. In some implementations, the batch loss is based on each of the query losses generated for the batch of training data 116 (e.g., the batch loss is based on a query loss for each of the queries in the set of queries for the batch of training data). Training engine can be used to update one or more portions of input model 110 and/or resource model 112 based on the generated batch loss.

Resource engine 108 can be used to generate electronic resource vectors 118 corresponding to a set of candidate electronic resources 120. In some implementations, resource engine 108 can process each candidate electronic resource in the set of candidate electronic resources 120 to generate a corresponding candidate electronic resource vector 118. In some implementations, candidate electronic resource vectors 118 can be stored locally at computing system 102. Additionally or alternatively, candidate electronic resource vectors 118 can be stored remote from computing system 102 and can be accessed by computing system 102.

Query engine 106 can be used to determine one or more candidate electronic resources 120 corresponding to a received query. In some implementations, the query can be received via one or more of the user interface input devices 104. For example, a natural language text query can be received via a keyboard, an image query can be captured via one or more cameras, a spoken utterance query can be captured using one or more microphones, and/or additional or alternative queries can be provided by a user. Query engine 106 can generate a corresponding query vector by processing the query using input model 110. Additionally or alternatively, query engine 106 can determine the electronic resource for the received query based on the distances between the query vector and the candidate electronic resource vectors 118. For example, the electronic resource can be determined based on the electronic resource vector closest to the query vector in the embedding space.

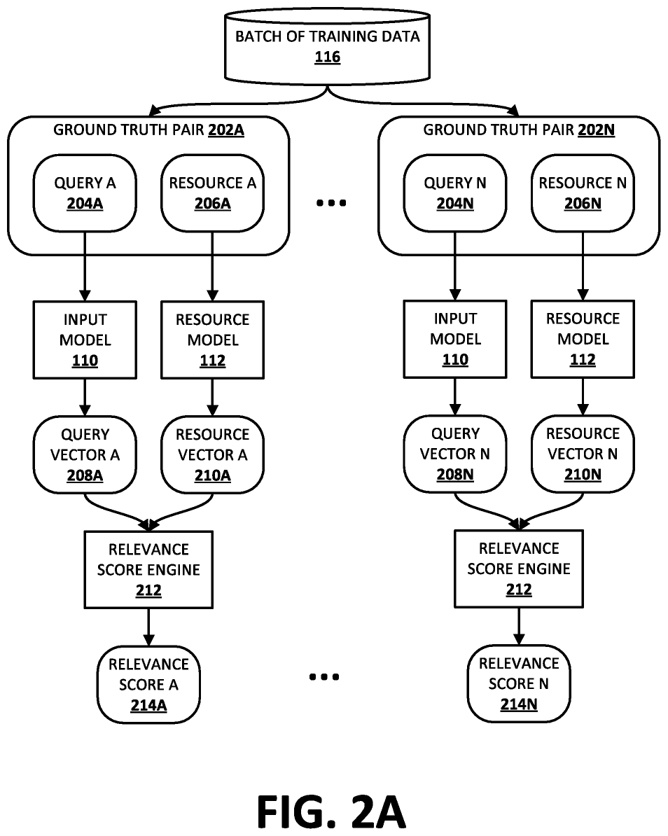

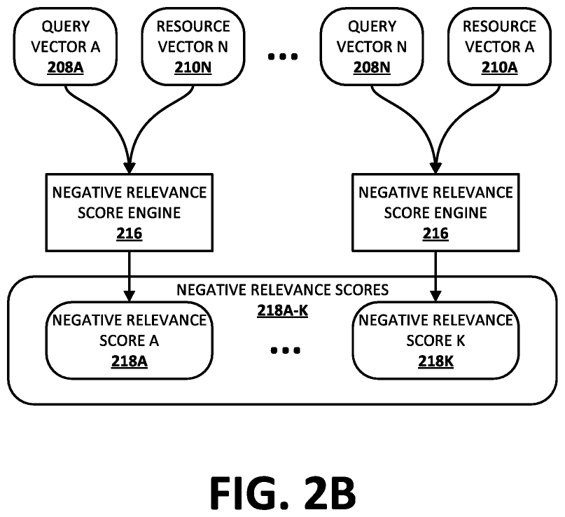

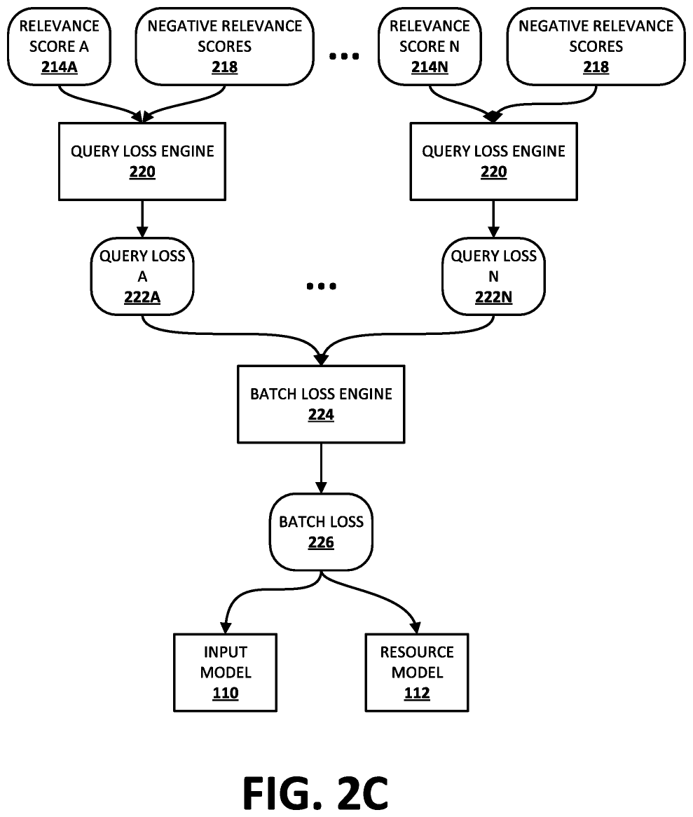

FIGS. 2A-2C illustrate training an input model and a resource model in accordance with some implementations. FIG. 2A illustrates an example of generating relevance scores 214A-N. In FIG. 2A, a batch of training data 116 includes ground truth query/electronic resource pairs 202A-202N. For example, ground truth pair 202A includes query A 204A and electronic resource A 206A. Similarly, ground truth pair 202N includes query N 204N and electronic resource N 206N. Each query 204A-N can be processed using input model 110 to generate a corresponding query vector (i.e., a embedding space representation of the corresponding query). For example, query A 204A can be processed using input model 110 to generate query vector A 208A. Similarly, query N 204N can be processed using input model 110 to generate query vector N 208N. Additionally or alternatively, each electronic resource 206A-N can be processed using resource model 112 to generate a corresponding electronic resource vector (i.e., an embedding space representation of the corresponding electronic resource). For example, electronic resource 206A can be processed using resource model 112 to generate electronic resource vector A 210A. Similarly, electronic resource 206N can be processed using resource model 112 to generate electronic resource vector N 210N.

In the illustrated example, relevance score engine 212 can be used to generate a relevance score for each query, in the batch of training data 116. For example, relevance score engine 212 can process query vector A 208A and electronic resource vector A 210A (i.e., the vectors corresponding to the ground truth pair 202A) to generate relevance score A 214A. Similarly, relevance score engine 212 can process query vector N 208N and electronic resource vector N 210N (i.e., the vectors corresponding to the ground truth pair 202N) to generate relevance score N 214N. In some implementations, relevance score engine 212 can generate a relevance score by determining a dot product between a query vector and an electronic resource vector. For example, relevance score A 214A can be generated using relevance score engine 212 by determining a dot product between query vector A 208A and electronic resource vector A 210A. Similarly, relevance score N 214N can be generated using relevance score engine 212 by determining a dot product between query vector N 208N and electronic resource vector N 210N.

FIG. 2B illustrates an example of generating negative relevance scores 218A-M. In FIG. 2B, negative relevance score engine 216 can be used to generate negative relevance scores 218A-K. In some implementations, negative relevance scores can be generated based on a given query and an electronic resource that is not the ground truth pair with the given query. In some implementations, negative relevance scores can be generated for each query electronic resource pair that is not a ground truth pair. For example, negative relevance score A 218A can be generated by processing query vector A 208A and electronic resource vector N 210N (i.e., a query vector and an electronic resource vector that do not correspond to a ground truth pair) using negative relevance score engine 216. Similarly, negative relevance score K 218K can be generated by processing query vector N 208N and electronic resource vector A 210A (i.e., a query vector and an electronic resource vector that do not correspond to a ground truth pair) using negative relevance score engine 216. In some implementations, negative relevance score engine 216 can generate a corresponding negative relevance score by determining a dot product between a query vector and an electronic resource vector. For example, negative relevance score A 218A can be generated by negative relevance score engine 216 by determining a dot product between query vector A 208A and electronic resource vector N 210N. Similarly, negative relevance score K 218K can be generated by negative relevance score engine 216 by determining a dot product between query vector N 208N and electronic resource vector A 210A.

FIG. 2C illustrates generating a batch loss 226 and using the generated batch loss 226 to update one or more portions of input model 110 and/or resource model 112 (e.g., update using backpropagation). In some implementations, a query loss can be determined for each query in the batch of training data based on the relevance score 214 corresponding to the query and one or more negative relevance scores 218, where at least one of the negative relevance scores 218 is generated for an additional query. In some implementations, query loss engine 220 can use each of the generated negative relevance scores (i.e., a cross-example Softmax method) in generating a query loss. For example, a query loss A 222A, corresponding to query A 204A, can be generated by processing relevance score A 214A, each negative relevance score generated for query A, and each negative relevance score generated for each additional query in the batch of training data 116. Similarly, query loss N 222N corresponding to query N 204N, can be generated by processing relevance score N 214N, each negative relevance score generated for query N, and each negative relevance score generated for each additional query in the batch of training data 116.

Additionally or alternatively, in some implementations, query loss engine 220 can use a subset of the generated negative relevance scores (i.e., a cross-example negative mining method) in generating a query loss. In some implementations, query loss engine 220 can determine the subset of the negative relevance scores which satisfy one or conditions. For example, query loss engine 220 can determine a subset of negative relevance scores, where each negative relevance score in the subset exceeds a threshold value, is a positive value, and/or satisfies one or more additional conditions. Additionally or alternatively, query loss engine 220 can determine a subset of negative relevance scores by selecting the k negative relevance scores with the highest values (e.g., selecting the top 10 negative relevance score values, the top 50 negative relevance score values, the top 100 negative relevance score values, and/or additional numbers of the top negative relevance score values). For example, query loss engine 220 can process relevance score A 214A and a subset of negative relevance scores 218 using query loss engine 220 to generate query loss A 222A. Similarly, relevance score N 214N and the subset of negative relevance scores 218 can be processed using query loss engine 220 to generate query loss N 222N. In some implementations, query loss engine 220 can determine the same subset of negative relevance score values. In some other implementations, query loss engine 220 can determine different subsets of negative relevance score values for one or more of the queries in the batch of training data.

In some implementations, query loss engine 220 can be used to generate a query loss for each query in the batch of training data. A batch loss can be generated based on one or more of the generated query losses. For example, batch loss engine 224 can process query loss A 222A and query loss N 222N to generate batch loss 226. One or more portions of input model 110 and/or resource model 112 can be updated using batch loss 226 (e.g., using backpropagation). FIGS. 2A-2C are described with respect to a batch of training data including two queries, two electronic resources, and corresponding ground truth pairings. However, this is merely an example, and the batch of training 116 can include additional queries, electronic resources, and/or ground truth pairings.

FIGS. 3A and 3B illustrates an embedding space 304 learned using a conventional Softmax technique (e.g., Sampled Softmax, Stochastic Negative Mining, etc.). FIG. 3A illustrates query A 302 (e.g., a vector representation of query A in embedding space 304) and candidate electronic resources 306, 308, and 310 (e.g., vector representations of electronic resources 306, 308, and 310 in embedding space 304). In the illustrated example, a system can determine electronic resource 306 is responsive to query A 302. For example, the system can determine the distance between the vector representation of query A 302 and the vector representation of electronic resource 306 is smaller than (1) the distance between the vector representation of query A 302 and the vector representation of electronic resource 308 and/or (2) the distance between the vector representation of query A 302 and the vector representation of electronic resource 310.

FIG. 3B illustrates query B 312 (e.g., a vector representation of query B in embedding space 304) and candidate electronic resources 314, 316, 318, and 320 (e.g., vector representations of electronic resources 314, 316, 318, and 320 in embedding space 304). In the illustrated example, a system can determine electronic resource 314 is responsive to query B 312. For example, the system can determine the distance between the vector representation of query B 312 and the vector representation of electronic resource 314 is smaller than (1) the distance between the vector representation of query B 312 and the vector representation of electronic resource 316, (2) the distance between the vector representation of query B 312 and the vector representation of electronic resource 318, and/or (3) the distance between the vector representation of query B 312 and the vector representation of electronic resource 320.

However, embedding space 304 has not been globally calibrated using cross-examples. While an electronic resource can be determined for query A and query B, the distances between the queries and the corresponding electronic resources are not comparable. For instance, the distance between query A 302 and its corresponding electronic resource 306 is greater than the distance between query B 312 and electronic resource 316 which is not responsive to query B.

In contrast, FIGS. 3C and 3D illustrate an embedding space 322 learned using cross-examples in accordance with some implementation described herein. FIG. 3C illustrates query A 302 (e.g., a vector representation of query A in embedding space 322) and candidate electronic resources 306, 308, and 310 (e.g., a vector representation of electronic resources 306, 308, and 310 in embedding space 322). FIG. 3D illustrates query B 312 (e.g., a vector representation of query B in embedding space 322) and candidate electronic resources 314, 316, 318, and 320 (e.g., a vector representation of electronic resources 314, 316, 318, and 320 in embedding space 322).

Similar to FIGS. 3A and 3B, a system can determine electronic resource 306 is responsive to query A 302 (e.g., based on the distance between the vector representation of query A 302 and the vector representation of electronic resource 306), and can determine electronic resource 314 is responsive to query B 312 (e.g., based on the distance between the vector representation of query B 312 and the vector representation of electronic resource 314).

However, embedding space 322 has been globally calibrated using cross-examples such that distances in the embedding space provide an indication of how relevant an electronic resource is to a query. For example, distances in embedding space 322 are globally calibrated such that the distance between query A and corresponding responsive electronic resource 306 is comparable to the distance between query B and corresponding responsive electronic resource 314. In the illustrated example, electronic resource 314 is closer to query B 312 than electronic resource 306 is to query A 302. In some implementations, this can indicate electronic resource 314 is more responsive to query B 312 than electronic resource 306 is to query A 302.

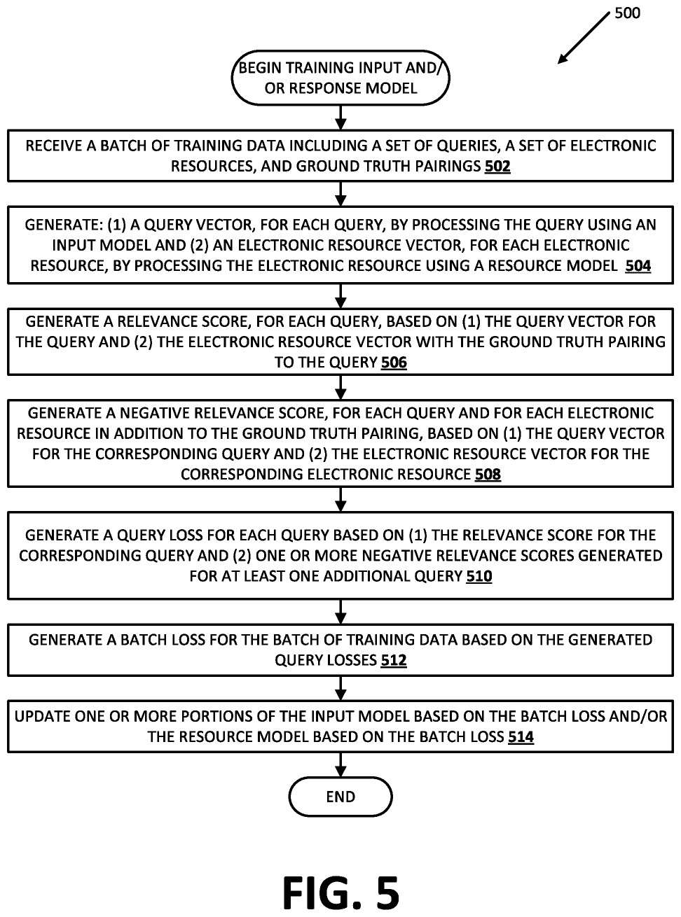

FIG. 5 is a flowchart illustrating a process 500 of training an input model and/or response model using cross-examples in accordance with implementations disclosed herein. For convenience, the operations of the flowchart are described with reference to a system that performs the operations. This system may include various components of various computer systems, such as one or more components of computing system 102, and/or computing system 910. Moreover, while operations of process 500 are shown in a particular order, this is not meant to be limiting. One or more operations may be reordered, omitted, and/or added.

At block 502, the system receives a batch of training data including a set of queries, a set of electronic resources, and ground truth pairings. In some implementations, each query has a corresponding electronic resource ground truth pairing. Additionally or alternatively, each electronic resource has a single corresponding ground truth pairing. For example, a batch of training data can include a set of natural language text queries, a set of images (i.e., the electronic resources), and ground truth pairings of the natural language text queries and the images. Additional and/or alternative set(s) of queries and/or set(s) of electronic resources can be utilized.

At block 504, the system generates a query vector for each query, in the set of queries, by processing the query using an input model. Additionally or alternatively, the system generates an electronic resource vector for each electronic resource, in the set of electronic resources, by processing the electronic resource using a resource model. For example, the system can generate a query vector by processing a corresponding query using input model 110 of FIG. 1. Additionally or alternatively, the system can generate an electronic resource vector by processing a corresponding electronic resource using resource model 112 of FIG. 1. In some implementations, each query vector is a shared embedding space representation of the corresponding query. Additionally or alternatively, each electronic resource is the shared embedding space representation of the corresponding electronic resource.

At block 506, the system generates a relevance score for each query, in the set of queries, based on (1) the query vector for the query and (2) the electronic resource vector with the ground truth paring to the query. For example, the system can determine the relevance score by determining a dot product between a corresponding query vector (e.g., a query vector generated at block 504) and a corresponding electronic resource vector (e.g., an electronic resource vector generated at block 504) for each of the ground truth pairings.

At block 508, the system generates a negative relevance score for each query and for each electronic resource in addition to the ground truth pairing, based on (1) the query vector for the corresponding query and (2) the electronic resource vector for the corresponding electronic resource. For example, for each query vector and each electronic resource vector which is not a ground truth pairing with the query vector, the system can determine a negative relevance score by determining a dot product between the corresponding query vector (e.g., a query vector generated at block 504) and the corresponding electronic resource vector (e.g., an electronic resource vector generated at block 504).

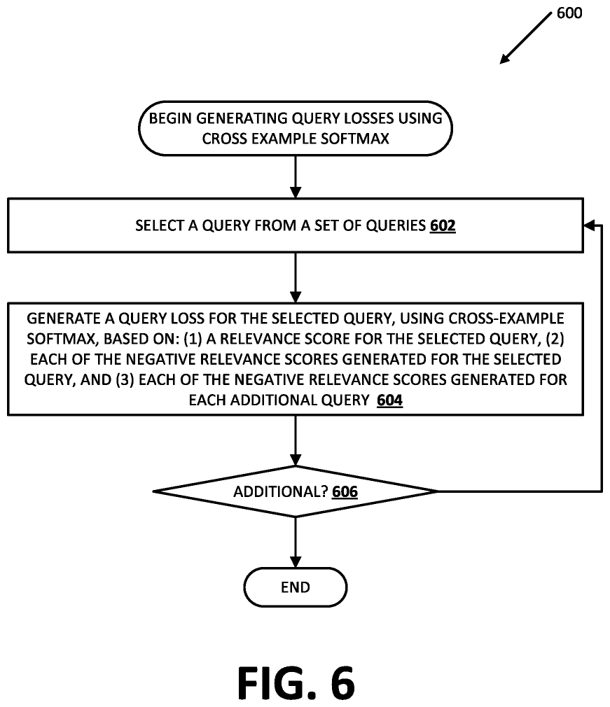

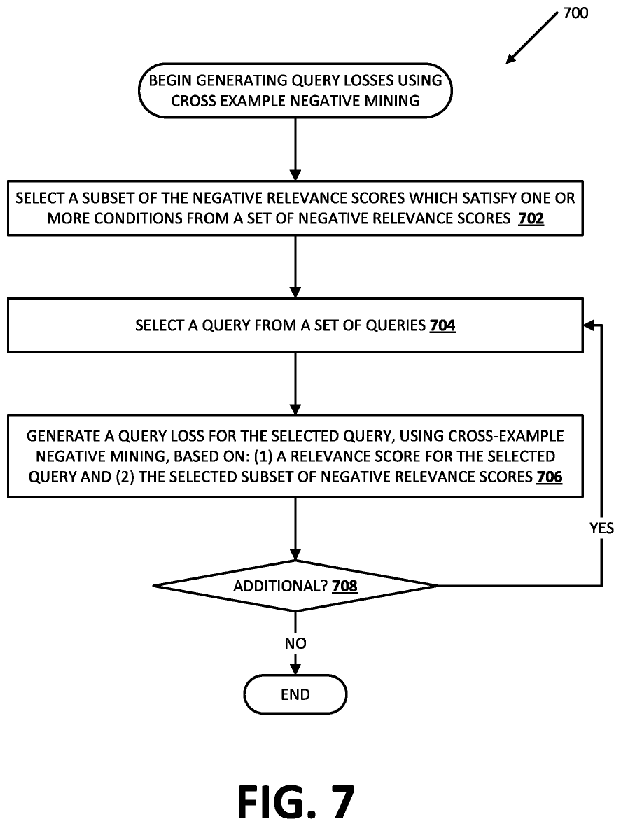

At block 510, the system generates a query loss for each query, in the set of queries, based on (1) the relevance score for the corresponding query and (2) one or more negative relevance scores generated for at least one additional query. In some implementations, the system can generate a query loss for each query using cross-example Softmax. Process 600 of FIG. 6 described herein is an example process of generating a query loss using cross-example Softmax. Additionally or alternatively, the system can generate a query loss for each query using cross-example negative mining. Process 700 of FIG. 7 described herein is an example process of generating a query loss using cross-example negative mining.

At block 512, the system generates a batch loss, for the batch of training data, based on the generated query losses. In some implementations, the system generates the batch loss based on a query loss generated for each query in the batch of training data.

At block 514, the system updates one or more portions of the input model and/or the resource model based on the batch loss (e.g., using backpropagation). For example, the system can update one or more portions of the input model used at block 504 to generate the query vectors using the batch loss. Additionally or alternatively, the system can update one or more portions of the resource model used at block 504 to generate the electronic resource vectors using the batch loss.

FIG. 6 is a flowchart illustrating a process 600 of generating a query loss using a cross-example Softmax method in accordance with implementations disclosed herein. For convenience, the operations of the flowchart are described with reference to a system that performs the operations. This system may include various components of various computer systems, such as one or more components of computing system 102, and/or computing system 910. Moreover, while operations of process 600 are shown in a particular order, this is not meant to be limiting. One or more operations may be reordered, omitted, and/or added.

At block 602, the system selects a query from a set of queries. In some implementations, query can be selected from a set of queries of a batch of training data. In some of those implementations, the batch of training data can include the set of queries, a set of electronic resources, and ground truth pairings of the queries and electronic resources. For example, the system can select the query from the batch of training data received at block 502 of process 500 of FIG. 5.

At block 604, the system generates a query loss for the selected query using cross-example Softmax based on (1) a relevance score generated for the selected query, (2) each of the negative relevance scores generated for the selected query, and (3) each of the negative relevance scores generated for each additional query. In other words, the system can generate a query loss for the selected query based on the relevance score for the selected query and each of the negative relevance scores generated for the batch of training data. In some implementations, the relevance score can be generated at block 506 of process 500 of FIG. 5. In some implementations, each of the negative relevance scores can be generated at block 508 of process 500 of FIG. 5.

At block 606, the system determines whether to process any additional queries. If so, the system proceeds back to block 602, selects an additional query from the set of queries, and proceeds to block 604 to generate an additional query loss for the selected additional query. If the system determines to not process any additional queries, the process ends. In some implementations, the system can determine to not process any additional queries when there are no remaining unprocessed queries in the set of queries and/or based on whether additional condition(s) are satisfied.

FIG. 7 is a flowchart illustrating a process 700 of generating a query loss using a Cross-Example Negative Mining method in accordance with implementations disclosed herein. For convenience, the operations of the flowchart are described with reference to a system that performs the operations. This system may include various components of various computer systems, such as one or more components of computing system 102, and/or computing system 910. Moreover, while operations of process 700 are shown in a particular order, this is not meant to be limiting. One or more operations may be reordered, omitted, and/or added.

At block 702, the system selects a subset of negative relevance scores which satisfy one or more conditions from a set of negative relevance scores. For example, the set of negative relevance scores can be generated at block 508 of process 500 of FIG. 5. For example, the system can select the subset of negative relevance scores based on whether a negative relevance score exceeds a threshold value, a negative relevance score does not exceed a threshold value, and/or whether additional or alternative condition(s) are satisfied. Additionally or alternatively, the system can select the top k negative relevance scores as the subset of negative relevance scores. For example, the system can select the top 20 negative relevance score values in the set of negative relevance scores. In some implementations, one or more negative relevance scores corresponding to a query are not selected in the subset of negative relevance scores. In some implementations, all of the negative relevance scores corresponding to a query are selected in the subset of negative relevance scores. In some implementations, none of the negative relevance scores corresponding to a query are selected in the subset of negative relevance scores.

At block 704, the system selects a query from the set of queries. In some implementations, query can be selected from a set of queries of a batch of training data used to generate the set of relevance scores. In some of those implementations, the batch of training data can include the set of queries, a set of electronic resources, and ground truth pairings of the queries and electronic resources. For example, the system can select the query from the batch of training data received at block 502 of process 500 of FIG. 5.

At block 706, the system generates a query loss for the selected query, using cross-example negative mining, based on (1) a relevance score generated for the selected query and (2) the selected subset of negative relevance scores.

At block 708, the system determines whether to process any additional queries. If so, the system proceeds back to block 704, selects an additional query from the set of queries, and proceeds to block 706 to generate an additional query loss for the selected additional query. If the system determines to not process any additional queries, the process ends. In some implementations, the system can determine to not process any additional queries when there are no remaining unprocessed queries in the set of queries and/or based on whether additional condition(s) are satisfied.

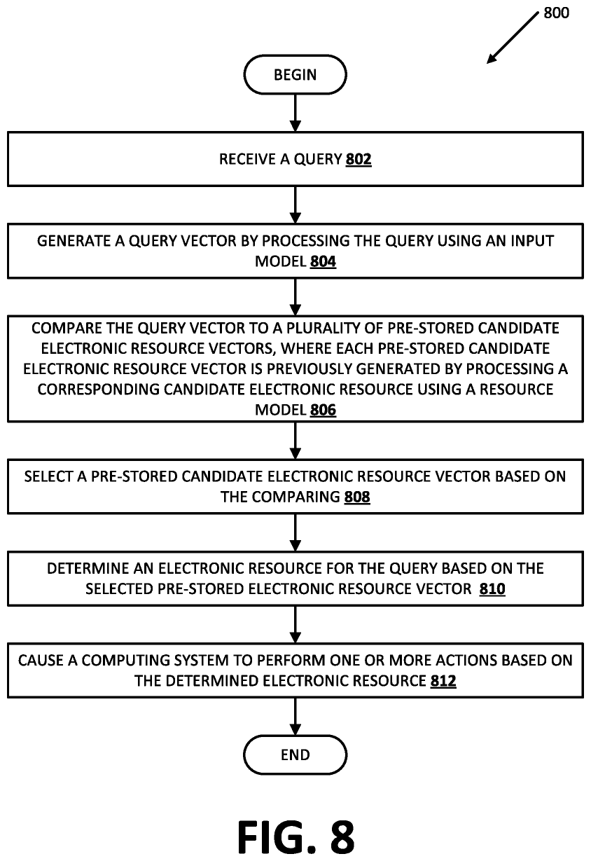

FIG. 8 is a flowchart illustrating a process 800 of determining an electronic resource for a query in accordance with implementations disclosed herein. For convenience, the operations of the flowchart are described with reference to a system that performs the operations. This system may include various components of various computer systems, such as one or more components of computing system 102, and/or computing system 910. Moreover, while operations of process 800 are shown in a particular order, this is not meant to be limiting. One or more operations may be reordered, omitted, and/or added.

At block 802, the system receives a query. For example, the system can receive a natural language text query from a user of a computing system.

At block 804, the system generates a query vector by processing the query using an input model.

At block 806, the system compares the query vector to a plurality of pre-stored candidate electronic resource vectors. In some implementations, each pre-stored candidate electronic resource vector is previously generated by processing a corresponding candidate electronic resource using a resource model. For example, the system can compare the query vector to a plurality of pre-stored candidate electronic resource vectors, where each candidate electronic resource vector corresponds to a candidate image for a candidate natural language text query. In some implementations, the system determines a distance between the query vector and each of the pre-stored candidate electronic resource vectors by determining a dot product between the query vector and the corresponding pre-stored candidate electronic resource vector.

At block 808, the system selects a pre-stored candidate electronic resource vector based on the comparing. In some implementations, the system can select the pre-stored candidate electronic resource vector closest to the query vector (e.g., the pre-stored candidate electronic resource vector with the smallest distance determined at block 806).

At block 810, the system determines an electronic resource for the query based on the selected pre-stored candidate electronic resource vector.

At block 812, the system causes a computing system to perform one or more actions based on the determined electronic resource. For example, the system can display the determined electronic resource on a screen for the user of a computing system. In some implementations, the system can provide the distance determined at block 806, between the corresponding query vector and the corresponding pre-stored electronic resource vector, to one or more components downstream from the system in a computing system. For example, the system can determine a bounding box (e.g., the electronic resource) for a provided image (e.g., the query). In some implementations, the system can provide the bounding box to an additional system which can be used to identify the object captured in the bounding box. Additionally or alternatively, the system can make a determination to not present an electronic resource to a user and instead can request additional information from the user (e.g., can request information clarifying the query, can request a new query, etc.). For instance, the system can receive an image as the query at block 802. The system can determine, based on comparing a corresponding query vector to a plurality of pre-stored candidate electronic resource vectors corresponding to a candidate bounding boxes, one or more bounding boxes for the image.

In some implementations, the system can receive a natural language query at block 802. The system can determine, based on comparing a corresponding query vector to a plurality of pre-stored candidate electronic resource vectors corresponding to candidate images, one or more images for the query. In some implementations, the system can render one or more electronic resources based on the comparison of the query vector to the pre-stored candidate electronic resource vectors (i.e., the relevance scores based on the query vector and the plurality of pre-stored electronic resource vectors). In some implementations, the system can directly link to a single electronic resource based on a relevance score which satisfies one or more conditions (e.g., the relevance score exceeds a threshold value indicating a high correlation between the query and the electronic resource). In some implementations, the system can render an electronic resource with a corresponding high relevance score, in a manner which, for example, emphasizes the electronic resource (e.g., more prominently renders the electronic resource, renders a large snippet of the electronic resource, etc.) while additional electronic resources with lower corresponding relevance scores are rendered without the emphasis. In some implementations, computing resources (e.g., bandwidth, processor cycles, memory, etc.) can be conserved by providing electronic resources to a user based on the relevance score corresponding to the electronic resource.

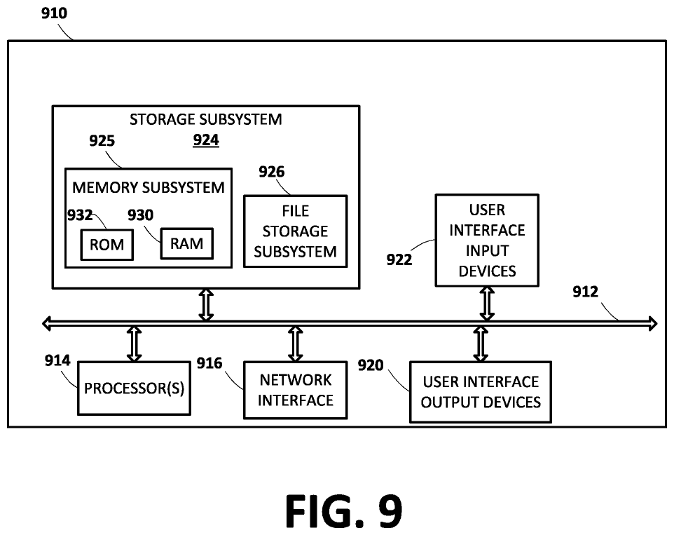

FIG. 9 is a block diagram of an example computing device 910 that may optionally be utilized to perform one or more aspects of techniques described herein. In some implementations, one or more of a client computing device, and/or other component(s) may comprise one or more components of the example computing device 910.

Computing device 910 typically includes at least one processor 914 which communicates with a number of peripheral devices via bus subsystem 912. These peripheral devices may include a storage subsystem 924, including, for example, a memory subsystem 925 and a file storage subsystem 926, user interface output devices 920, user interface input devices 922, and a network interface subsystem 916. The input and output devices allow user interaction with computing device 910. Network interface subsystem 916 provides an interface to outside networks and is coupled to corresponding interface devices in other computing devices.

User interface input devices 922 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computing device 910 or onto a communication network.

User interface output devices 920 may include a display subsystem, a printer, a fax machine, or non-visual displays such as audio output devices. The display subsystem may include a cathode ray tube (“CRT”), a flat-panel device such as a liquid crystal display (“LCD”), a projection device, or some other mechanism for creating a visible image. The display subsystem may also provide non-visual display such as via audio output devices. In general, use of the term “output device” is intended to include all possible types of devices and ways to output information from computing device 910 to the user or to another machine or computing device.

Storage subsystem 924 stores programming and data constructs that provide the functionality of some or all of the modules described herein. For example, the storage subsystem 924 may include the logic to perform selected aspects of one or more of the processes of FIG. 5, FIG. 6, FIG. 7, and/or FIG. 8, as well as to implement various components depicted in FIG. 1.

These software modules are generally executed by processor 914 alone or in combination with other processors. Memory 925 used in the storage subsystem 924 can include a number of memories including a main random access memory (“RAM”) 930 for storage of instructions and data during program execution and a read only memory (“ROM”) 932 in which fixed instructions are stored. A file storage subsystem 926 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 926 in the storage subsystem 924, or in other machines accessible by the processor(s) 914.

Bus subsystem 912 provides a mechanism for letting the various components and subsystems of computing device 910 communicate with each other as intended. Although bus subsystem 912 is shown schematically as a single bus, alternative implementations of the bus subsystem may use multiple busses.

Computing device 910 can be of varying types including a workstation, server, computing cluster, blade server, server farm, or any other data processing system or computing device. Due to the ever-changing nature of computers and networks, the description of computing device 910 depicted in FIG. 9 is intended only as a specific example for purposes of illustrating some implementations. Many other configurations of computing device 910 are possible having more or fewer components than the computing device depicted in FIG. 9.

In situations in which the systems described herein collect personal information about users (or as often referred to herein, “participants”), or may make use of personal information, the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

In some implementations, a method implemented by one or more processors is provided, the method including identifying a batch of training data that includes a set of queries, a set of electronic resources, and ground truth parings, wherein each of the ground truth pairings is of a corresponding one of the electronic resources to a corresponding one of the queries, and wherein each of the electronic resources has only a corresponding single one of the ground truth pairings. In some implementations, for each query in the set of queries, the method includes generating a corresponding query vector by processing the query using an input model. In some implementations, for each electronic resource in the set of electronic resources, the method includes generating a corresponding electronic resource vector by processing the electronic resource using a resource model. In some implementations, for each query in the set of queries, the method includes generating a relevance score based on (1) the corresponding query vector generated for the query and (2) the corresponding electronic resource vector generated for the electronic resource with the ground truth pairing to the query. In some implementations, the method includes generating, for each electronic resource that is in addition to the corresponding electronic resource with the ground truth pairing to the query, a corresponding negative relevance score based on (1) the corresponding query vector generated for the query and (2) the electronic resource vector generated for the electronic resource that is in addition to the corresponding electronic resource with the ground truth relationship to the query. In some implementations, the method includes generating a query loss based on (1) the relevance score generated for the query and (2) at least one corresponding negative relevance score generated for at least one additional query in the set of queries. In some implementations, the method includes generating a batch loss, for the batch of training data, based on the generated query losses. In some implementations, the method includes updating one or more portions of the input model and/or the resource model based on the generated batch loss.

These and other implementations of the technology disclosed herein can include one or more of the following features.

In some implementations, generating the query loss based on (1) the relevance score generated for the query and (2) the at least one corresponding negative relevance score generated for at least one additional query in the set of queries includes generating the query loss based on (1) the relevance score generated for the query, (2) the corresponding negative relevance scores generated for the query, and (3) all of the corresponding negative relevance scores generated for each of the additional queries in the set of queries.

In some implementations, generating the query loss based on (1) the relevance score generated for the query and (2) the at least one corresponding negative relevance score generated for at least one additional query in the set of queries includes selecting a subset of the negative relevance scores, wherein the selected subset includes at least one negative relevance score generated for at least one additional query in the set of queries, and wherein selecting the subset is based on the corresponding negative relevance scores of the subset satisfying one or more conditions. In some implementations, the method includes generating the query loss based on (1) the relevance score generated for the query and (2) the subset of the corresponding negative relevance scores.

In some implementations, each query, in the set of queries, is a natural language query, and wherein each electronic resource, in the set of electronic resources, is an image or a web page.

In some implementations, each query, in the set of queries, is an image capturing an object, and wherein each electronic resource, in the set of electronic resources, represents one or more corresponding bounding boxes.

In some implementations, subsequent to updating the one or more portions of the input model and/or the resource model based on the generated batch loss, the method further includes deploying the trained input model on a computing system. In some implementations, the method includes receiving a user query via one or more user interface input devices of the computing system. In some implementations, the method includes determining a user query vector by processing the user query using the trained input model. In some implementations, the method includes determining a user electronic resource responsive to the user query based, wherein determining the user electronic resource responsive to the user query includes comparing the user query vector with a plurality of pre-stored candidate electronic resource vectors, wherein each pre-stored candidate electronic resource vector, in the plurality of pre-stored candidate electronic resource vectors, is previously generated by processing a corresponding electronic resource using the resource model. In some implementations, the method includes selecting a pre-stored candidate electronic resource vector based on the comparing. In some implementations, the method includes determining the user electronic resource based on the selected pre-stored candidate electronic resource vector. In some implementations, the method includes causing the computing system to perform one or more actions based on the determined user electronic resource.

In some implementations, for each query in the set of queries, generating the relevance score based on (1) the corresponding query vector generated for the query and (2) the corresponding electronic resource vector generated for the electronic resource with the ground truth pairing to the query includes determining a dot product between (1) the corresponding query vector generated for the query and (2) the corresponding electronic resource vector generated for the electronic resource with the ground truth pairing to the query. In some implementations, the method includes generating the relevance score based on the determined dot product.

In some implementations, for each query in the set of queries, generating, for each electronic resource that is in addition to the corresponding electronic resource with the ground truth pairing to the query, the corresponding negative relevance score based on (1) the corresponding query vector generated for the query and (2) the electronic resource vector generated for the electronic resource that is in addition to the corresponding electronic resource with the ground truth relationship to the query includes determining a dot product between (1) the corresponding query vector generated for the query and (2) the electronic resource vector generated for the electronic resource that is in addition to the corresponding electronic resource with the ground truth relationship to the query. In some implementations, the method includes generating the negative relevance score based on the determined dot product.

In some implementations, the generated query vector, for each query in the set of queries, projects the query into a shared embedding space, and wherein the electronic resource vector, for each electronic resource in the set of electronic resources, projects the electronic resource into the shared embedding space.

In some implementations, a method implemented by one or more processors is provided, the method including receiving an image capturing an object. In some implementations, the method includes generating an image vector by processing the image using an input model. In some implementations, determining a bounding box for the object captured in the image, wherein determining the bounding box for the object includes comparing the image vector to a plurality of pre-stored candidate bounding box vectors, wherein each pre-stored candidate bounding box vector, in the plurality of pre-stored candidate bounding box vectors, is previously generated by processing a corresponding candidate bounding box using a resource model. In some implementations, the method includes selecting a pre-stored candidate bounding box vector based on the comparing. In some implementations, the method includes determining the bounding box for the object based on the selected pre-stored candidate bounding box vector. In some implementations, the method includes causing a computing device to perform one or more actions based on the determined bounding box for the object.

In addition, some implementations include one or more processors (e.g., central processing unit(s) (CPU(s)), graphics processing unit(s) (GPU(s), and/or tensor processing unit(s) (TPU(s)) of one or more computing devices, where the one or more processors are operable to execute instructions stored in associated memory, and where the instructions are configured to cause performance of any of the methods described herein. Some implementations also include one or more transitory or non-transitory computer readable storage media storing computer instructions executable by one or more processors to perform any of the methods described herein.

1. A method implemented by one or more processors, the method comprising:
identifying a batch of training data that includes a set of queries, a set of electronic resources, and ground truth parings, wherein each of the ground truth pairings is of a corresponding one of the electronic resources to a corresponding one of the queries, and wherein each of the electronic resources has only a corresponding single one of the ground truth pairings;
for each query in the set of queries, generating a corresponding query vector by processing the query using an input model;
for each electronic resource in the set of electronic resources, generating a corresponding electronic resource vector by processing the electronic resource using a resource model;
for each query in the set of queries,
generating a relevance score based on (1) the corresponding query vector generated for the query and (2) the corresponding electronic resource vector generated for the electronic resource with the ground truth pairing to the query; and
generating, for each electronic resource that is in addition to the corresponding electronic resource with the ground truth pairing to the query, a corresponding negative relevance score based on (1) the corresponding query vector generated for the query and (2) the electronic resource vector generated for the electronic resource that is in addition to the corresponding electronic resource with the ground truth relationship to the query;
generating a query loss based on (1) the relevance score generated for the query and (2) at least one corresponding negative relevance score generated for at least one additional query in the set of queries;
generating a batch loss, for the batch of training data, based on the generated query losses; and
updating one or more portions of the input model and/or the resource model based on the generated batch loss.

2. The method of claim 1, wherein generating the query loss based on (1) the relevance score generated for the query and (2) the at least one corresponding negative relevance score generated for at least one additional query in the set of queries comprises:
generating the query loss based on (1) the relevance score generated for the query, (2) the corresponding negative relevance scores generated for the query, and (3) all of the corresponding negative relevance scores generated for each of the additional queries in the set of queries.

3. The method of claim 1, wherein generating the query loss based on (1) the relevance score generated for the query and (2) the at least one corresponding negative relevance score generated for at least one additional query in the set of queries comprises:
selecting a subset of the negative relevance scores, wherein the selected subset includes at least one negative relevance score generated for at least one additional query in the set of queries, and wherein selecting the subset is based on the corresponding negative relevance scores of the subset satisfying one or more conditions; and
generating the query loss based on (1) the relevance score generated for the query and (2) the subset of the corresponding negative relevance scores.

4. The method of claim 1, wherein each query, in the set of queries, is a natural language query, and wherein each electronic resource, in the set of electronic resources, is an image or a web page.

5. The method of claim 1, wherein each query, in the set of queries, is an image capturing an object, and wherein each electronic resource, in the set of electronic resources, represents one or more corresponding bounding boxes.

6. The method of claim 1, further comprising, subsequent to updating the one or more portions of the input model and/or the resource model based on the generated batch loss:
deploying the trained input model on a computing system;
receiving a user query via one or more user interface input devices of the computing system;
determining a user query vector by processing the user query using the trained input model;
determining a user electronic resource responsive to the user query based, wherein determining the user electronic resource responsive to the user query comprises:
comparing the user query vector with a plurality of pre-stored candidate electronic resource vectors, wherein each pre-stored candidate electronic resource vector, in the plurality of pre-stored candidate electronic resource vectors, is previously generated by processing a corresponding electronic resource using the resource model;
selecting a pre-stored candidate electronic resource vector based on the comparing; and
determining the user electronic resource based on the selected pre-stored candidate electronic resource vector; and
causing the computing system to perform one or more actions based on the determined user electronic resource.

7. The method of claim 1, wherein, for each query in the set of queries, generating the relevance score based on (1) the corresponding query vector generated for the query and (2) the corresponding electronic resource vector generated for the electronic resource with the ground truth pairing to the query comprises:
determining a dot product between (1) the corresponding query vector generated for the query and (2) the corresponding electronic resource vector generated for the electronic resource with the ground truth pairing to the query; and
generating the relevance score based on the determined dot product.

8. The method of claim 1, wherein, for each query in the set of queries, generating, for each electronic resource that is in addition to the corresponding electronic resource with the ground truth pairing to the query, the corresponding negative relevance score based on (1) the corresponding query vector generated for the query and (2) the electronic resource vector generated for the electronic resource that is in addition to the corresponding electronic resource with the ground truth relationship to the query comprises:
determining a dot product between (1) the corresponding query vector generated for the query and (2) the electronic resource vector generated for the electronic resource that is in addition to the corresponding electronic resource with the ground truth relationship to the query; and
generating the negative relevance score based on the determined dot product.

9. The method of claim 1, wherein the generated query vector, for each query in the set of queries, projects the query into a shared embedding space, and wherein the electronic resource vector, for each electronic resource in the set of electronic resources, projects the electronic resource into the shared embedding space.

10. A method implemented by one or more processors, the method comprising:
receiving an image capturing an object;
generating an image vector by processing the image using an input model;
determining a bounding box for the object captured in the image, wherein determining the bounding box for the object comprises:
comparing the image vector to a plurality of pre-stored candidate bounding box vectors, wherein each pre-stored candidate bounding box vector, in the plurality of pre-stored candidate bounding box vectors, is previously generated by processing a corresponding candidate bounding box using a resource model;
selecting a pre-stored candidate bounding box vector based on the comparing; and
determining the bounding box for the object based on the selected pre-stored candidate bounding box vector; and
causing a computing device to perform one or more actions based on the determined bounding box for the object.

11. (canceled)

12. (canceled)

13. (canceled)

14. A system comprising:
memory storing instructions;
one or more processors operable to execute the instructions, stored in the memory, to:
identify a batch of training data that includes a set of queries, a set of electronic resources, and ground truth parings, wherein each of the ground truth pairings is of a corresponding one of the electronic resources to a corresponding one of the queries, and wherein each of the electronic resources has only a corresponding single one of the ground truth pairings;
for each query in the set of queries, generate a corresponding query vector by processing the query using an input model;
for each electronic resource in the set of electronic resources, generate a corresponding electronic resource vector by processing the electronic resource using a resource model;
for each query in the set of queries,
generate a relevance score based on (1) the corresponding query vector generated for the query and (2) the corresponding electronic resource vector generated for the electronic resource with the ground truth pairing to the query; and
generate, for each electronic resource that is in addition to the corresponding electronic resource with the ground truth pairing to the query, a corresponding negative relevance score based on (1) the corresponding query vector generated for the query and (2) the electronic resource vector generated for the electronic resource that is in addition to the corresponding electronic resource with the ground truth relationship to the query;
generate a query loss based on (1) the relevance score generated for the query and (2) at least one corresponding negative relevance score generated for at least one additional query in the set of queries;
generate a batch loss, for the batch of training data, based on the generated query losses; and
update one or more portions of the input model and/or the resource model based on the generated batch loss.

15. The system of claim 14, wherein in generating the query loss based on (1) the relevance score generated for the query and (2) the at least one corresponding negative relevance score generated for at least one additional query in the set of queries, one or more of the processors are to:
generate the query loss based on (1) the relevance score generated for the query, (2) the corresponding negative relevance scores generated for the query, and (3) all of the corresponding negative relevance scores generated for each of the additional queries in the set of queries.

16. The system of claim 14, wherein in generating the query loss based on (1) the relevance score generated for the query and (2) the at least one corresponding negative relevance score generated for at least one additional query in the set of queries, one or more of the processors are to:
select a subset of the negative relevance scores, wherein the selected subset includes at least one negative relevance score generated for at least one additional query in the set of queries, and wherein selecting the subset is based on the corresponding negative relevance scores of the subset satisfying one or more conditions; and
generate the query loss based on (1) the relevance score generated for the query and (2) the subset of the corresponding negative relevance scores.

17. The system of claim 14, wherein each query, in the set of queries, is a natural language query, and wherein each electronic resource, in the set of electronic resources, is an image or a web page.

18. The system of claim 14, wherein each query, in the set of queries, is an image capturing an object, and wherein each electronic resource, in the set of electronic resources, represents one or more corresponding bounding boxes.

19. The system of claim 14, wherein the generated query vector, for each query in the set of queries, projects the query into a shared embedding space, and wherein the electronic resource vector, for each electronic resource in the set of electronic resources, projects the electronic resource into the shared embedding space.
